(19) United States
(12) Patent Application Publication
(10) Pub. No.: US 2012/0253959 A1
(43) Pub. Date: Oct. 4, 2012

(54) LICENSE UPGRADE MANAGEMENT

(75) Inventors: Ziquan Li, Redmond, WA (US); Sunil S. Kadam, Redmond, WA (US); Sanjeev Dwivedi, Sammamish, WA (US); Alwin Vyhmeister, Seattle, WA (US); Ariye M. Cohen, Bellevue, WA (US)

(73) Assignee: Microsoft Corporation, Redmond, WA (US)

(21) Appl. No.: 13/076,457

(22) Filed: Mar. 31, 2011

(51) Int. Cl. G06F 21/22; H04L 9/32; G06Q 30/00

(52) U.S. Cl. 705/26.1; 726/28; 726/5

(57) ABSTRACT

The claimed subject matter provides a method for managing license upgrades in a computing environment. An exemplary method includes sending a request to upgrade a license status of application software program. The method further includes receiving licensing information indicating a change to the license status of the software program, the change to the license status of the software program being sufficient to allow the user to use the software program under the changed status automatically, and without further action by a user.

### BACKGROUND

When purchasing software, a user may first obtain a trial version at little or no cost. The trial version may not be fully functional, or may be fully functional for a limited period of time (for example, 30 days or a specific number of uses). In some cases, the trial version and the full version may be completely separate programs, which must be downloaded (or otherwise purchased) at different times. If so, the user may first install the trial version to explore whether the program fulfills the user's intended need. If the user wishes to upgrade to the full version, the full version must then be purchased and separately installed.

Alternatively, the trial version and the full version may exist in a single program. In such a case, the user loads the program, which initially functions as the trial version. A serial number or other activation code may be needed to enable all of the features and functionality of the full version. If the user wishes to obtain a license to use the full version, the serial number or activitation code may be purchaseed and used to upgrade the trial version to a full version.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The claimed subject matter provides a method for managing license upgrades in a computing environment. An exemplary method includes sending a request to change a license status of a software program. The method further includes receiving licensing information indicating a change to the license status of the software program, the change to the license status of the software program being sufficient to allow the user to use the software program under the changed status automatically, and without further action by a user.

One embodiment of the claimed subject matter relates to a system for managing license upgrades. An exemplary system for managing license upgrades comprises a processing unit and a system memory. The system memory comprises code configured to direct the processing unit to send a request to obtain a software program. The system memory also comprises code that directs the processing unit to receive the software program and to receive licensing information indicating a license status of the software program. Additional code stored in the system memory directs the processing unit to send a request to change the license status of the software program. The system memory further comprises code that directs the processor to receive licensing information indicating a change to the license status of the software program. According to the subject innovation, the change to the license status of the software program is itself sufficient to automatically allow the user to use the software program under an upgrade status, without further action by a user.

Another embodiment of the claimed subject matter relates to one or more computer-readable storage media that store license upgrade management code. The license upgrade management code is configured to direct a processing unit to send a request to obtain a trial version of an application program, and to receive the application program and licensing information indicating that a license status of the application program is a trial status. The license upgrade management code also causes the processing unit to send a request to upgrade the license status of the application program. Additionally, the license upgrade management code causes the processing unit to receive licensing information indicating an upgrade to the license status of the application program. According to the subject innovation, the change to the license status of the application program is sufficient to allow the user to automatically use the application program under the upgrade status without further action by a user.

### BRIEF DESCRIPTION OF THE DRAWINGS

FIG. 1 is a block diagram of a system in which license upgrading according to the subject innovation may be practiced;

FIG. 2 is a process flow diagram of a method of managing license upgrades in a computing environment according to the subject innovation;

FIG. 3 is a block diagram of an exemplary networking environment wherein aspects of the claimed subject matter can be employed; and

FIG. 4 is a block diagram of an exemplary operating environment for implementing various aspects of the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “client” and the like are intended to refer to a computer-related entity, either hardware, software (e.g., in execution), and/or firmware, or a combination thereof. For example, a component can be a process running on a processor, an object, an executable, a program, a function, a library, a subroutine, and/or a computer or a combination of software and hardware.

By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any non-transitory computer-readable device, or media.

Non-transitory computer-readable storage media can include but are not limited to magnetic storage devices (e.g., hard disk, floppy disk, and magnetic strips, among others), optical disks (e.g., compact disk (CD), and digital versatile disk (DVD), among others), smart cards, and flash memory devices (e.g., card, stick, and key drive, among others). In contrast, computer-readable media generally (i.e., not necessarily storage media) may additionally include communication media such as transmission media for wireless signals and the like.

Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

According to the subject innovation, a user may obtain a trial version of software, such as an application program. If the user later purchases a license to the full version of the software, licensing information indicating a fully licensed status is automatically delivered without any other user interaction. When the licensed software is next used, it operates as fully licensed based on the licensing information. Moreover, the user's trial version of the software is automatically upgraded to a full version without any additional steps, such as manually entering credentials, manually activating the application or downloading any additional data.

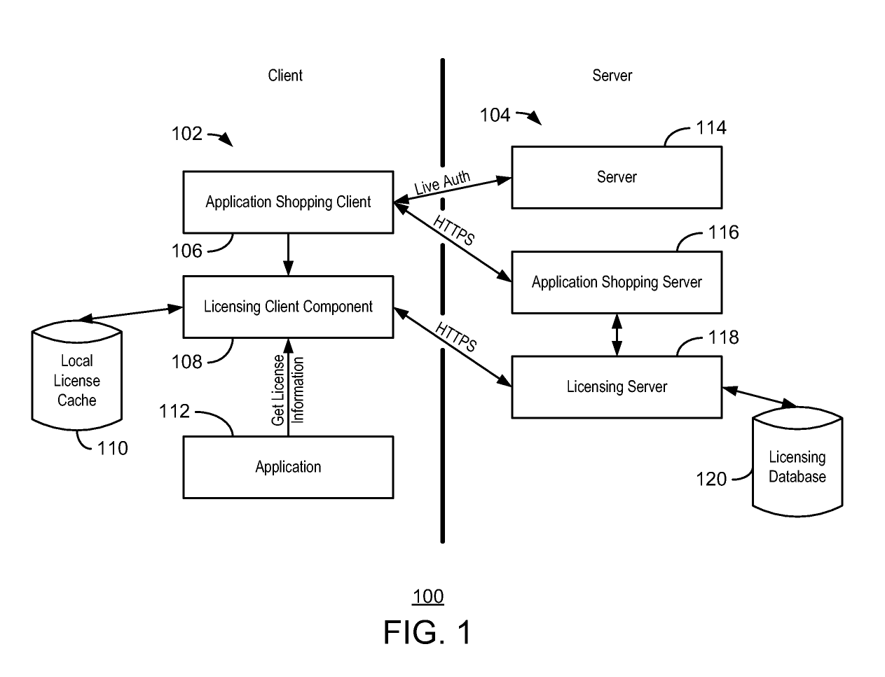

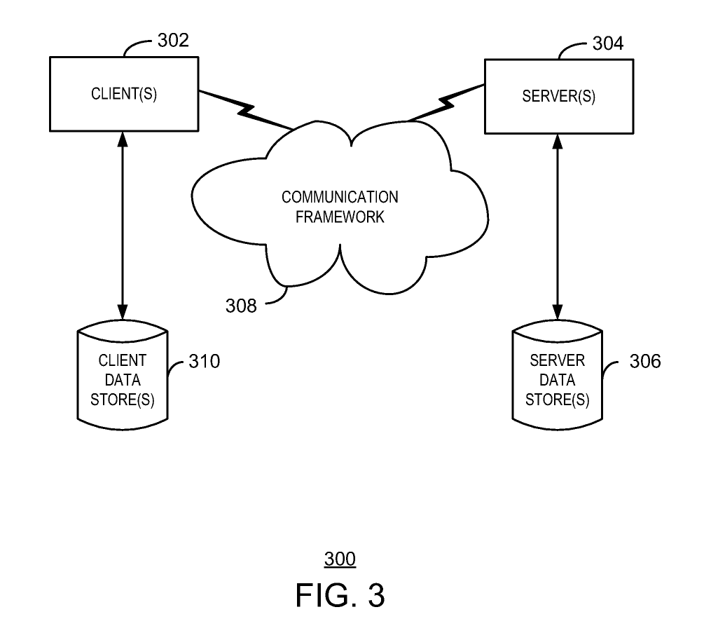

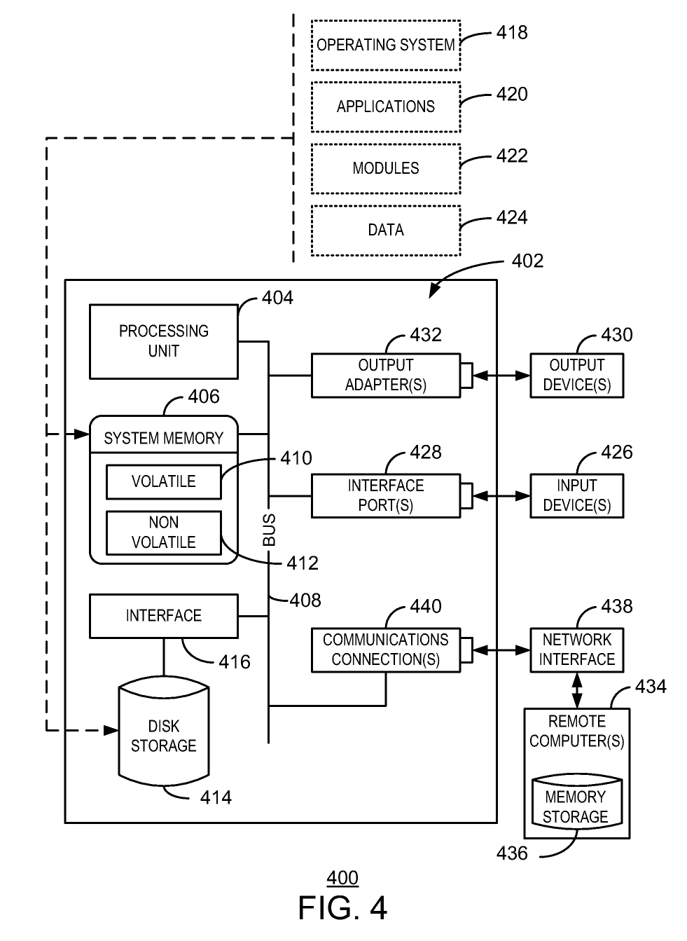

FIG. 1 is a block diagram of a system 100 in which license upgrading according to the subject innovation may be practiced. The system 100 includes a client environment 102 depicted in a left panel of FIG. 1. As explained herein with reference to FIGS. 3 and 4, the client environment 102 may be implemented in a client computing system. A right panel of FIG. 1 depicts a server environment 104, such as a server computing system. The server environment 104 represented in the right panel may be disposed, for example, in a server computing system in a cloud computing environment. Moreover, the server environment 104 may be connected to a network such as the Internet.

The client environment 102 comprises an application shopping client 106. An example of an application shopping client 106 in a Windows® computing environment is a Windows® Store client. In an example embodiment, the application shopping client 106 may be implemented as a component or module of an operating system. The application shopping client 106 communicates with an authentication server and an application shopping server, as explained herein.

A licensing client component 108 is also included in the client environment 102. The licensing client component 108 maintains licensing information in a local license cache 110 of the client environment 102. The licensing client component 108 may receive licensing information from a licensing server, as explained herein.

An application program 112 may be executed in the client environment 102. The application program 112 may obtain license information from the local license cache 110 via the licensing client component 108. Certain features of the application program 112 may be disabled depending on the licensing information. For example, if the licensing information indicates that only a trial version of the application program 112 has been obtained, certain advanced features of the application program 112 may be disabled. Alternatively, the application program 112 may be entirely disabled if, for example, the licensing information indicates that a trial period of the application program 112 has expired.

The server environment 104 includes a server 114 that, among other things, provides authentication when a user of the client environment 102 logs in. Moreover, the user may have an account on the server 114, and may log in for the purpose of buying a software application. One example of the server 114 in a Windows® computing environment is a Windows Live® server.

The server environment 104 includes an application shopping server 116 that may provide the user of the client environment 102 with a selection of software applications available for purchase. After being authenticated by the server 114, the application shopping client 106 may engage in a secure connection with the application shopping server 116. One example of the application shopping server 116 in a Windows® computing environment is a Windows® Store server.

The application shopping server 116 may have access to a licensing server 118. One example of the licensing server 118 in a Windows® computing environment is a Windows® Store licensing server. The licensing server 118 may in turn access license information stored in a licensing database 120. The licensing database 120 may provide correct licensing information such as a serial number or authentication code when a user obtains a software application from the application shopping server 116. Moreover, the licensing server 118 may engage in a secure connection with the licensing client component 108 to provide the user of the client environment 102 with the licensing information.

According to the subject innovation, an application having a trial license is initially acquired from the application shopping server 116. Licensing information indicating the trial license status is obtained from the licensing database 120 via the licensing server 118 and provided to the user. In an example embodiment, the licensing information is provided via a secure connection between the licensing server 118 and the licensing client component 108. After being received by the licensing client component 108, the license information is stored in the local license cache 110. The user is then authorized to use the application under the trial license in the client environment 102.

Each time the application is initiated in the client environment 102, the application queries the local license cache 110 for its licensing status. After the trial license is recorded in the local license cache 110, a trial licensing status will be returned and the application will operate according to the terms of the trial license.

In one embodiment, the application, when operating as a trial version, may initiate a prompt of the user to purchase a full license. For example, the application, upon determining its trial licensing status, may place a call to the licensing client component 108 to initiate a prompt of the user. Moreover, the prompt to the user may encourage the user to upgrade the trial license to a full license for a payment, which may be made via the user's account on the server 114. If the user attempts to initiate the application after expiration of the trial license period, the application may fail to start. In this situation, the licensing client component 108 may provide a prompt to the user to upgrade the license for a payment.

When a full license is purchased by the user, licensing information indicating a full license is automatically obtained from the licensing database 120 via a secure connection between the licensing client component 108 and the licensing server 118. The licensing information indicating that a full license has been purchased is then automatically stored in the local license cache 110. Thereafter, a licensing status indicating a full license is returned when the application is initiated in the client environment 102, and queries the local license cache 110 for the status of the license rights for the application. The change in the license status stored in the local license cache 110 from trial license to full license is in itself sufficient to allow the application to be executed as a fully licensed application. In this manner, the user is able to begin using the application as a fully licensed version without the inconvenience of having to download another version of the application. In addition, the user is not required to obtain and enter a lengthy activation code or the like to change the license status of the application from trial version to full version.

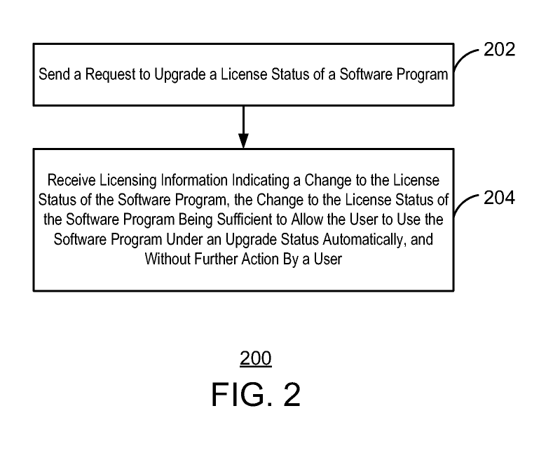

FIG. 2 is a process flow diagram of a method 200 of managing license upgrades in a computing environment according to the subject innovation. In an example embodiment, a request to obtain a trial version of a software program is sent. The software program and licensing information indicating a license status of the software program may be received.

Subsequently, a user may desire to upgrade the license of the application program, for example, from a trial version to a full version. At block 202 of FIG. 2, a request to change the license status of the software program is sent. The request may be accompanied by, for example, payment information for a full license. At block 204, licensing information indicating a change to the license status of the software program is received. According to the subject innovation, the change to the license status of the software program is in itself sufficient to allow the user to use the software program under the changed status automatically, and without further action by a user. Moreover, when the software program is initiated, it may query the local license cache 110 to determine the licensing status of the software program. When the license information indicating that the software program is fully licensed is retrieved, the software program executes under the terms of the changed license without further action on the part of the user.

FIG. 3 is a block diagram of an exemplary networking environment 300 wherein aspects of the claimed subject matter can be employed. Moreover, the exemplary networking environment 300 may be used to implement a system and method of licensing software according to the subject innovation.

The networking environment 300 includes one or more client(s) 302. The client(s) 302 can be hardware and/or software (e.g., threads, processes, computing devices). As an example, the client(s) 302 may be computers providing access to servers over a communication framework 308, such as the Internet. The client(s) 302 may correspond to the client environment 102 shown and described herein with reference to FIG. 1.

The environment 300 also includes one or more server(s) 304. The server(s) 304 can be hardware and/or software (e.g., threads, processes, computing devices). The server(s) 304 may include network storage systems. The server(s) may be accessed by the client(s) 302. As described herein, the server(s) 304 may correspond to the server environment 104 shown and described herein with reference to FIG. 1.

One possible communication between a client 302 and a server 304 can be in the form of a data packet adapted to be transmitted between two or more computer processes. The environment 300 includes a communication framework 308 that can be employed to facilitate communications between the client(s) 302 and the server(s) 304.

The client(s) 302 are operably connected to one or more client data store(s) 310 that can be employed to store information local to the client(s) 302. The client data store(s) 310 may be located in the client(s) 302, or remotely, such as in a cloud server. One example of the client data store(s) 310 includes the local license cache 110 shown and described in FIG. 1. Similarly, the server(s) 304 are operably connected to one or more server data store(s) 306 that can be employed to store information local to the servers 304. An example of the server data store(s) 306 includes the licensing database 120 shown and described in FIG. 1.

With reference to FIG. 4, an exemplary operating environment 400 is shown for implementing various aspects of the claimed subject matter. The exemplary operating environment 400 includes a computer 402. The computer 402 includes a processing unit 404, a system memory 406, and a system bus 408. The computer 402 may form a portion of either the client environment 102 or the server environment 104.

The system bus 408 couples system components including, but not limited to, the system memory 406 to the processing unit 404. The processing unit 404 can be any of various available processors. Dual microprocessors and other multiprocessor architectures also can be employed as the processing unit 404.

The system bus 408 can be any of several types of bus structure(s) including the memory bus or memory controller, a peripheral bus or external bus, and/or a local bus using any variety of available bus architectures known to those of ordinary skill in the art. The system memory 406 comprises non-transitory computer-readable storage media that includes volatile memory 410 and non-volatile memory 412.

The basic input/output system (BIOS), containing the basic routines to transfer information between elements within the computer 402, such as during start-up, is stored in non-volatile memory 412. By way of illustration, and not limitation, non-volatile memory 412 can include read only memory (ROM), programmable ROM (PROM), electrically programmable ROM (EPROM), electrically erasable programmable ROM (EEPROM), or flash memory.

Volatile memory 410 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), SynchLink™ DRAM (SLDRAM), Rambus® direct RAM (RDRAM), direct Rambus® dynamic RAM (DRDRAM), and Rambus® dynamic RAM (RDRAM).

The computer 402 also includes other non-transitory computer-readable media, such as removable/non-removable, volatile/non-volatile computer storage media. FIG. 4 shows, for example a disk storage 414. Disk storage 414 includes, but is not limited to, devices like a magnetic disk drive, floppy disk drive, tape drive, Jaz drive, Zip drive, LS-100 drive, flash memory card, or memory stick.

In addition, disk storage 414 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 414 to the system bus 408, a removable or non-removable interface is typically used such as interface 416.

It is to be appreciated that FIG. 4 describes software that acts as an intermediary between users and the basic computer resources described in the suitable operating environment 400. Such software includes an operating system 418. Operating system 418, which can be stored on disk storage 414, acts to control and allocate resources of the computer 402.

System applications 420 take advantage of the management of resources by operating system 418 through program modules 422 and program data 424 stored either in system memory 406 or on disk storage 414. It is to be appreciated that the claimed subject matter can be implemented with various operating systems or combinations of operating systems.

A user enters commands or information into the computer 402 through input device(s) 426. Input devices 426 include, but are not limited to, a pointing device (such as a mouse, trackball, stylus, or the like), a keyboard, a microphone, a joystick, a satellite dish, a scanner, a TV tuner card, a digital camera, a digital video camera, a web camera, and/or the like. The input devices 426 connect to the processing unit 404 through the system bus 408 via interface port(s) 428. Interface port(s) 428 include, for example, a serial port, a parallel port, a game port, and a universal serial bus (USB).

Output device(s) 430 use some of the same type of ports as input device(s) 426. Thus, for example, a USB port may be used to provide input to the computer 402, and to output information from computer 402 to an output device 430.

Output adapter 432 is provided to illustrate that there are some output devices 430 like monitors, speakers, and printers, among other output devices 430, which are accessible via adapters. The output adapters 432 include, by way of illustration and not limitation, video and sound cards that provide a means of connection between the output device 430 and the system bus 408. It can be noted that other devices and/or systems of devices provide both input and output capabilities such as remote computer(s) 434.

The computer 402 can be a server hosting various software applications in a networked environment using logical connections to one or more remote computers, such as remote computer(s) 434. The remote computer(s) 434 may be client systems configured with web browsers, PC applications, mobile phone applications, and the like.

The remote computer(s) 434 can be a personal computer, a server, a router, a network PC, a workstation, a microprocessor based appliance, a mobile phone, a peer device or other common network node and the like, and typically includes many or all of the elements described relative to the computer 402.

For purposes of brevity, only a memory storage device 436 is illustrated with remote computer(s) 434. Remote computer(s) 434 is logically connected to the computer 402 through a network interface 438 and then physically connected via a communication connection 440.

Network interface 438 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 440 refers to the hardware/software employed to connect the network interface 438 to the bus 408. While communication connection 440 is shown for illustrative clarity inside computer 402, it can also be external to the computer 402. The hardware/software for connection to the network interface 438 may include, for exemplary purposes only, internal and external technologies such as, mobile phone switches, modems including regular telephone grade modems, cable modems and DSL modems, ISDN adapters, and Ethernet cards.

An exemplary processing unit 404 for the server may be a computing cluster comprising Intel® Xeon CPUs. The disk storage 414 may comprise an enterprise data storage system, for example, holding thousands of impressions.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable storage media having computer-executable instructions for performing the acts and/or events of the various methods of the claimed subject matter.

There are multiple ways of implementing the subject innovation, e.g., an appropriate API, tool kit, driver code, operating system, control, standalone or downloadable software object, etc., which enables applications and services to use the techniques described herein. The claimed subject matter contemplates the use from the standpoint of an API (or other software object), as well as from a software or hardware object that operates according to the techniques set forth herein. Thus, various implementations of the subject innovation described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical).

Additionally, it can be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A method for managing license upgrades, comprising:
sending a request to change a license status of a software program; and
receiving licensing information indicating a change to the license status of the software program, the change to the license status of the software program being sufficient to allow the user to use the application program under the changed status automatically, and without further action by a user.

2. The method recited in claim 1, comprising:
querying a storage device to obtain the license status; and
running the software program based on the license status received from the storage device.

3. The method recited in claim 1, wherein the request to change the license status includes payment information.

4. The method recited in claim 1, wherein the change to the license status comprises an upgrade from a trial status to a fully-licensed status.

5. The method recited in claim 1, comprising storing the licensing information indicating the change to the license status in a local license cache.

6. The method recited in claim 1, comprising providing user authentication information prior to sending a request to obtain a trial version of the software program, such that a user is logged in to an account through which the software program is obtained.

7. The method recited in claim 1, comprising prompting a user to request a license upgrade prior to sending the request to change the license status.

8. A system for managing license upgrades, comprising:
a processing unit; and
a system memory, wherein the system memory comprises code configured to direct the processing unit to:
send a request to obtain a software program;
receive the software program and licensing information indicating a license status of the software program;
send a request to change the license status of the software program; and
receive licensing information indicating a change to the license status of the software program, the change to the license status of the software program being sufficient to allow the user to use the software program under an upgrade status automatically, and without further action by a user.

9. The system recited in claim 8, comprising a local license cache that stores the license information of the software program.

10. The system recited in claim 8, wherein the software program queries a storage device to obtain the license status, and executes based on the license status received from the storage device.

11. The system recited in claim 8, wherein the request to change the license status includes payment information.

12. The system recited in claim 8, wherein the change to the license status comprises a change from the trial status to a fully-licensed status.

13. The system recited in claim 8, wherein user authentication information is provided prior to sending a request to obtain a trial version of the software program, such that a user is logged in to an account through which the software program is obtained.

14. The system recited in claim 8, wherein a user is prompted to request a license upgrade prior to sending the request to change the license status.

15. One or more computer-readable storage media, comprising license upgrade management code configured to direct a processing unit to:
send a request to obtain a trial version of an application program;
receive the application program and licensing information indicating that a license status of the application program is a trial status;
send a request to upgrade the license status of the application program; and
receive licensing information indicating an upgrade to the license status of the application program, the change to the license status of the application program being sufficient to allow the user to use the application program under the upgrade status automatically, and without further action by a user.

16. The one or more computer-readable storage media recited in claim 15, comprising a local license cache that stores the license information of the application program.

17. The one or more computer-readable storage media recited in claim 15, wherein the application program queries a storage device to obtain the license status, and executes based on the license status received from the storage device.

18. The one or more computer-readable storage media recited in claim 15, wherein the request to upgrade the license status includes payment information.

19. The one or more computer-readable storage media recited in claim 15, wherein the upgrade to the license status comprises a change from the trial status to a fully-licensed status.

20. The one or more computer-readable storage media recited in claim 15, wherein user authentication information is provided prior to sending a request to obtain a trial version of an application program, such that a user is logged in to an account through which the application program is obtained.
